(19) United States
(12) Patent Application Publication
(10) Pub. No.: US 2015/0218055 A1
(43) Pub. Date: Aug. 6, 2015

(54) SETTER PLATE FOR SINTERING

(71) Applicant: ALCOA INC., Pittsburgh, PA (US)

(72) Inventors: James C. McMillen, Pittsburgh, PA (US); Jason Bick, Verona, PA (US)

(21) Appl. No.: 14/308,132

(22) Filed: Jun. 18, 2014

Related U.S. Application Data
(60) Provisional application No. 61/936,796, filed on Feb. 6, 2014.

(51) Int. Cl. C04B 35/58; C04B 35/64

(52) U.S. Cl. CPC C04B 35/58071; C04B 35/64

(57) ABSTRACT

In one aspect of the instant disclosure, a setter plate assembly to sinter green titanium dioxide forms, such as aluminum smelting cathodes made by multiple forming methods is produced. The assembly is itself formed from sintered titanium diboride. The open area of the assembly and vents allow off-gassing during settering to producing a sintered product with reduced contamination. The setter plate assembly is made principally from titanium diboride, which is chemically compatible with green titanium dioxide forms.

### CROSS-REFERENCE TO RELATED APPLICATIONS

This patent application is a non-provisional of and claims priority to U.S. Provisional Patent Application No. 61/836,796 filed Jun. 19, 2013, which is incorporated herein by reference in its entirety.

### FIELD OF THE INVENTION

The present invention relates to kiln furniture and supports for green parts fired in a kiln, and more particularly, to a setter plate for supporting green items during sintering.

### BACKGROUND OF THE INVENTION

Various types of kiln furniture and setter plates with various compositions, such as mullite, cordierite and silicon carbide are known. Because setter plates and the green items supported thereon are subjected to high temperatures in a kiln, reactions may take place between the green item and setter plates made from certain materials. Alternative setter plate designs and compositions that reduce reactions between the setter plate and the green item are therefore desirable.

### SUMMARY OF THE INVENTION

The disclosed subject matter relates to a setter plate for supporting an article while the article is fired in a kiln. In one embodiment, the setter plate is a porous plate formed from sintered titanium diboride having a particle size in the range of 10 to 12 microns and having an open area between 20% to 50%.

In another embodiment, the setter plate is capable of allowing the infiltration of compounds emitted by the article supported on the setter plate while heating the article in a kiln.

In another embodiment, the article is made from titanium diboride and the setter plate is capable of supporting the article in the kiln without chemically reacting with the article while the article is heated in the kiln.

In another embodiment, the setter plate has a plurality of sub-components, including a bottom plate, a top plate and at least one side plate, the side plate spacing the top plate from the bottom plate and defining a space there between for receiving the article.

In another embodiment, the top plate and the bottom plate are coextensive rectangular plates and the at least one side plate includes four side plates distributed peripherally around the rectangular top and bottom plates.

In another embodiment, the side plates are castellated cut-outs having at least one promontory and at least one valley, the valleys capable of venting the space between the top plate and the bottom plate.

In another embodiment, a method of forming a titanium diboride article includes:

(A) forming a slurry of titanium diboride powder in a liquid binder;

(B) filling a mold having a cavity with the shape of the article with the slurry;

(C) allowing the slurry in the cavity to dry to a solid form;

(D) placing the solid form on a titanium diboride setter in a kiln;

(E) heating the solid form to drive off the binder; and

(F) sintering the solid form to yield the titanium diboride article.

In another embodiment, a method for making a setter plate, includes: at least one of slip casting, spray drying and pressing, roll compaction, and making pastes/castable mixes and forcing into molds to yield a solid form.

In another embodiment, the solid form is placed on a titanium diboride surface within a kiln and heated to yield setter plate material.

In another embodiment, the method further includes cutting the setter plate material into a top plate, a bottom plate and side plates and assembling the top, bottom and side plates into a setter plate assembly defining an envelope with a space therein for receiving an article to be settered.

In another embodiment, the method further includes making a plurality of cavities corresponding to a top plate, a bottom plate and side plates in a mold, filling each of the plurality of cavities and then sintering the mold in a kiln to yield a top plate, a bottom plate and side plates; and further comprising the step of assembling the top plate, bottom plate and side plates into a setter plate assembly having an interior space capable of receiving an article therein for settering.

In another embodiment, the article is a cathode for an aluminum smelter.

In another embodiment, the setter is chemically compatible with the article.

In another embodiment, the setter is porous and further comprising the step of infiltrating the porous setter when the step of driving off the binder is conducted.

In another embodiment, the method includes the step of passing binder compounds through the porous setter.

In another embodiment, the setter is a setter assembly having a plurality of plates surrounding an interior hollow in which the article is received prior to the step of heating.

In another embodiment, the method includes the step of stacking a plurality of setter plate assemblies with contained articles within a kiln.

In another embodiment, the method includes:

(A) forming a slurry of titanium diboride powder in a liquid binder;

(B) filling a mold having a cavity with the shape of an article from which the setter plate may be made with the slurry;

(C) allowing the slurry in the cavity to dry to a solid form;

(D) placing the solid form in a kiln;

(E) heating the solid form to drive off the binder;

(F) sintering the solid form to yield the setter plate material; and

(G) using the setter plate material to form the setter plate.

In another embodiment, the solid form is placed on a titanium diboride surface within the kiln prior to the step of heating.

In another embodiment, the step of using, includes cutting the setter plate material into a top plate, a bottom plate and side plates and assembling the top, bottom and side plates into a setter plate assembly defining an envelope with a space therein for receiving an article to be settered.

In another embodiment, the mold of step (B) has a plurality of cavities corresponding to a top plate, a bottom plate and side plates, each of which a filled during the step of filling and are processed in the steps (C) through (G) to yield a top plate, a bottom plate and side plates; and further comprising the step of assembling the top plate, bottom plate and side plates into a setter plate assembly having an interior space capable of receiving an article therein for settering.

In another embodiment, the step of assembling includes driving pins through the top plate, bottom plate and side plates to hold the setter plate assembly together.

### BRIEF DESCRIPTION OF THE DRAWINGS

For a more complete understanding of the present disclosure, reference is made to the following detailed description of exemplary embodiments considered in conjunction with the accompanying drawings.

FIG. 1 is perspective view of a setter plate assembly in accordance with an embodiment of the present disclosure.

FIG. 2 is perspective view of the setter plate assembly of FIG. 1 with the top plate off and an article containable therein.

### DETAILED DESCRIPTION OF EXEMPLARY EMBODIMENTS

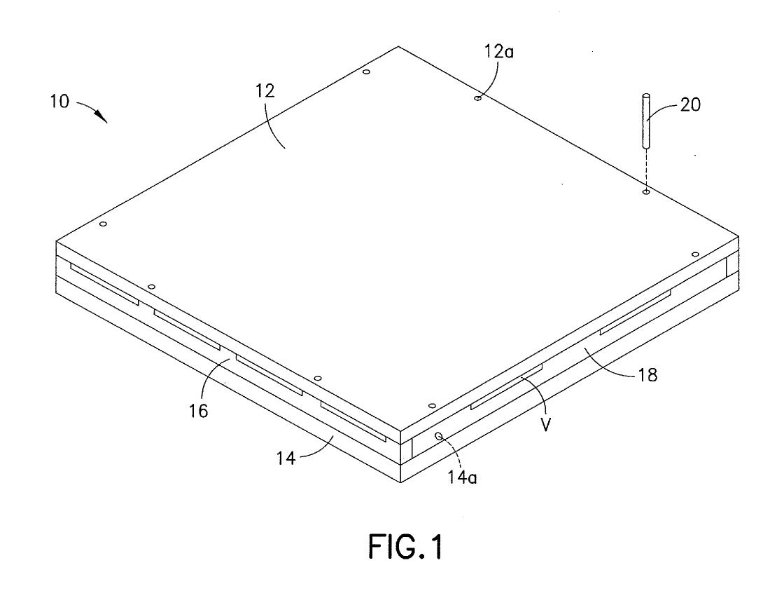

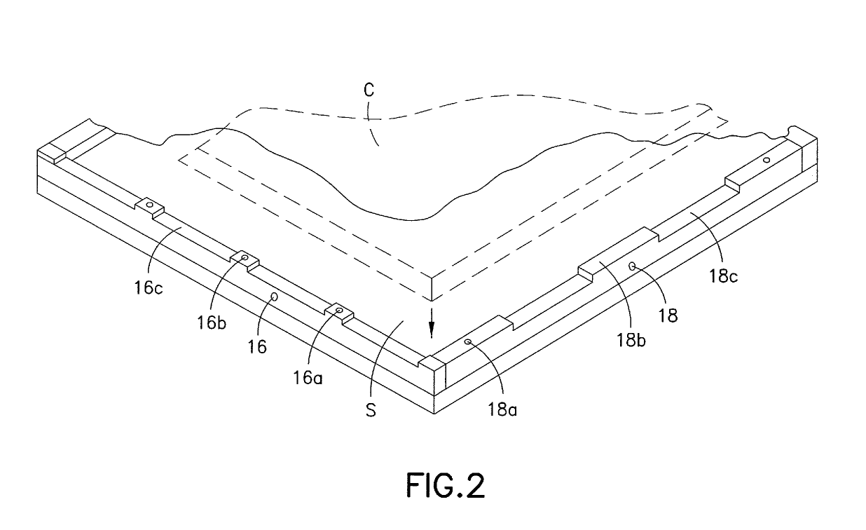

FIGS. 1 and 2 show a setter plate assembly 10 having a top plate 12, and a bottom plate 14 separated by pairs of side plates 16 and end plates 18, defining an internal space 5, the side plate 16 and end plate 18 shown being replicated on the opposite respective sides of the setter plate assembly 10 which are not visible in FIG. 1. In one embodiment, the setter plate assembly 10 is described as an envelope containing the space S and/or any object placed in space S before the assembly 10 is completed. More specifically, in this embodiment, the article C is placed upon the bottom plate 14 and then side plates 16 and end plates 18 are arranged around the article C on the periphery of the bottom plate 14 in the configuration shown in FIG. 2. The top plate 12 is then placed on the side plates 16 and end plates 18 to cover the article C. In one embodiment, the side plates 16 and end plates 18 are arranged on the bottom plate 14 and then the article C is placed on the bottom plate between them. The side plates 16 and the end plates 18 are castellated (e.g. a configuration with slots/notches cut into one end, e.g. a toothed configuration), having promontories 16b, 18b (e.g. a raised portion or projection of material) respectively, and intermediate valleys 16c, 18c, respectively. In some embodiments, after the article C is positioned in the space S, pins 20 are driven into aligned apertures 12a, 14a, 16a, 18a to secure the setter plate assembly 10 together. In some embodiments, the pins are made from a heat resistant material, such as tungsten or molybdenum. In some embodiments, the pins have a chamfer (e.g. a relief, configured to enable introduction of the pin into the hole) on one or both ends to facilitate introduction into the setter plate assembly 10. Without being bound by a particular mechanism or theory, this is believed to be appropriate for use in kilns having high velocity positive venting. For example, the voids defined by the valleys 16c, 18c relative to the top plate 12 are configured to function as vents V for the passage of off gases emitted by the article C, e.g., when the article C, contained within the setter plate assembly 10 is placed in a kiln and subjected to heat. In one embodiment, the side plates 16 and end plates 18 are cut from a larger sheet of material, with the remaining part of the sheet being used as the top plate 12 and/or bottom plate 14. In some embodiments, the promontories and valleys 16b, 16c and 18b, 18c are formed by machining (i.e. electrical discharge machining/wire cutting) or by casting in a mold, as further described below.

In accordance with the present disclosure, a setter plate assembly 10 is configured to have sufficient strength to support a green article C before, during and after firing in a kiln, which allows the article C to retain a given shape throughout the process of firing. Another aspect is that the setter assembly 10 is that it is chemically non-reactive with the article C, in particular in the high heat environment of a kiln during firing.

In some embodiments, the setter plates are configured to fashion certain articles, such as cathodes used in aluminum smelters, from titanium diboride (TiB₂). Without being bound by a particular mechanism or theory, it is believed that setter plates made from graphite, boron nitride, cordierite, mullite, zircon, alumina and silicon carbide are reactive and/or lose strength sufficient to support green titanium diboride articles C at the necessary firing temperatures. Without being bound by a particular mechanism or theory, titanium diboride is utilizable as a material for forming a setter plate, where the setter plate is chemically compatible with titanium diboride articles supported thereby in a kiln—and—further that the setter plate assembly 10 may be used for that purpose (e.g., maintain sufficient strength to support green titanium diboride articles C at the necessary firing temperatures).

One non-limiting approach to forming a titanium diboride article C, such as a cathode, is by forming a slurry of titanium diboride particles in a liquid binder, e.g., a polymer, e.g., acrylic. In one approach, a slurry with a liquid and an organic binder that is soluble or emulsified in/by the liquid and TiB2 powder. The slurry is spray or flash dried and the dried material is placed (usually in agglomerated form) into a mold and compacted with mechanical pressure. Another method is slip casting. In some cases of refractory materials, a wet paste mix or castable (similar to concrete) is compacted into a mold and then dried. Roll compaction or tape casting are other methods to form ceramics. The green article C is then fired in a kiln, for example, at temperatures of about 1500° C. to 2200° C. for 0 to 10 hours. This firing process results in of the sintering and densification of the green titanium diboride article. The components 12, 14, etc. of the setter plate assembly 10 may be formed in a similar manner using the same composition. The initial titanium diboride setter may be formed by known processes, such as by hot pressing titanium diboride powder, e.g., at 1800° C. in a graphite die or by utilizing a setter plate that is settered on a chemically reactive surface, such as graphite, and then subsequently machined to remove the surface that has been chemically effected, e.g., removing a boron carbide surface layer. Once formed, the setter plate assembly 10 may be utilized to setter articles C, such as a cathode plate in green form made from titanium diboride cast in a mold in a similar manner to that used to produce the components 12, 14, 16, 18 of the setter plate assembly 10, that may be accommodated within the space S defined by the envelope formed by the setter plate assembly 10. The setter plate assembly 10 containing the article C may be placed in a kiln and subjected to temperatures required for firing/sintering the article C. Optionally, more than one setter plate assembly 10 with contained articles C may be loaded into a kiln, e.g., by stacking one setter plate assembly 10 on another directly, by utilizing conventional kiln furniture to space them, or otherwise arranging the setter plate assemblies 10 within the kiln, e.g., a graphite kiln, in an efficient manner.

In one embodiment, during firing/sintering of the article C, the article emits off-gases. As a non-limiting example, in the case of a cast green titanium diboride cathode, the green casting will emit various organic compounds when the binder is volatilized and/or burned during firing. In one embodiment, the vents V provided in the setter plate assembly 10 may vent some of the gases into the kiln. In one embodiment, the gases are removed from the kiln by venting the kiln. In some embodiments, venting conducted by negative or positive pressure venting. In some embodiments, since sintered titanium diboride formed in accordance with the above-described process for making the components 12, 14, 16, 18 has a density ranging from about 2.7 to 3.0 g/cm³ and an open area ranging from 20%-50%, In these embodiments, the off-gases pass into and through the components 12, 14, 16, 18 into the kiln for removal. As a non-limiting example, a flat article C, like a titanium diboride cathode in the green state has substantially the entire lower surface thereof in contact with the bottom plate 14 of the setter plate assembly in which it is contained during settering/firing. In this embodiments, without being bound by any mechanism or theory, it is believed that the off-gases emitted by the article C in this area of close contact, due to the porosity of the bottom plate 14, at least partially penetrate into the surface of the bottom plate 14 in contact with the article C and pass through the bottom plate 14 out of the setter plate assembly 10 and into the kiln for removal/venting. In this manner, the resultant titanium diboride cathode (article C) is produced with reduced contamination by off-gases and related solids from the green article.

An aspect of the present disclosure is a setter plate assembly having the capacity to setter green titanium diboride forms, such as for use as cathodes, made by low pressure casting of titanium diboride slurries or methods described above and producing a sintered product with reduced contamination from off-gases and reduced contamination of the surface of the sintered product due to contact with the setter plate assembly 10, the setter plate assembly 10 being made principally from titanium diboride, which is chemically compatible with the sintered product.

It will be understood that the embodiments described herein are merely exemplary and that a person skilled in the art may make many variations and modifications without departing from the spirit and scope of the present disclosure. All such variations and modifications are intended to be included within the scope of the present disclosure.

What is claimed is:

1. A setter plate for supporting an article while the article is fired in a kiln, comprising:
a porous plate formed from sintered titanium diboride having an open area between 20% to 50%.

2. The setter plate of claim 1, wherein the setter plate is capable of allowing the infiltration of compounds emitted by the article supported on the setter plate while heating the article in a kiln.

3. The setter plate of claim 1, wherein the article is made from titanium diboride and the setter plate is capable of supporting the article in the kiln without chemically reacting with the article while the article is heated in the kiln.

4. The setter plate of claim 1, wherein the setter plate has a plurality of sub-components, including a bottom plate, a top plate and at least one side plate, the side plate spacing the top plate from the bottom plate and defining a space there between for receiving the article.

5. The setter plate of claim 4, wherein the top plate and the bottom plate are coextensive rectangular plates and the at least one side plate includes four side plates distributed peripherally around the rectangular top and bottom plates.

6. The setter plate of claim 5, wherein the side plates are castellated having at least one promontory and at least one valley, the valleys capable of venting the space between the top plate and the bottom plate.

7. A method of forming a titanium diboride article, comprising:
(A) forming a slurry of titanium diboride powder in a liquid binder;
(B) filling a mold having a cavity with the shape of the article with the slurry;
(C) allowing the slurry in the cavity to dry to a solid form;
(D) placing the solid form on a titanium diboride setter in a kiln;
(E) heating the solid form to drive off the binder; and
(F) sintering the solid form to yield the titanium diboride article.

8. The method of claim 7, wherein the article is a cathode for an aluminum smelter.

9. The method of claim 7, wherein the setter is chemically compatible with the article.

10. The method of claim 7, wherein the setter is porous and further comprising the step of infiltrating the porous setter when the step of driving off the binder is conducted.

11. The method of claim 10, further comprising the step of passing binder compounds through the porous setter.

12. The method of claim 11, wherein the setter is a setter assembly having a plurality of plates surrounding an interior hollow in which the article is received prior to the step of heating.

13. The method of claim 13, further comprising the step of stacking a plurality of setter plate assemblies with contained articles within a kiln.

14. A method for making a setter plate, comprising: at least one of slip casting, spray drying and pressing, roll compaction, and making pastes/castable mixes and forcing into molds to yield a solid form.

15. The method of claim 14, wherein the solid form is placed on a titanium diboride surface within a kiln and heated to yield setter plate material.

16. The method of claim 15, further including cutting the setter plate material into a top plate, a bottom plate and side plates and assembling the top, bottom and side plates into a setter plate assembly defining an envelope with a space therein for receiving an article to be settered.

17. The method of claim 14, further including making a plurality of cavities corresponding to a top plate, a bottom plate and side plates in a mold, filling each of the plurality of cavities and then sintering the mold in a kiln to yield a top plate, a bottom plate and side plates; and further comprising the step of assembling the top plate, bottom plate and side plates into a setter plate assembly having an interior space capable of receiving an article therein for settering.

18. The method of claim 17, wherein the step of assembling includes driving pins through the top plate, bottom plate and side plates to hold the setter plate assembly together.

19. The setter plate of claim 1, wherein the particle size of the titanium diboride is in the range of 10 to 12 microns.
